(19) United States
(12) Patent Application Publication
(10) Pub. No.: US 2026/0313601 A1
(43) Pub. Date: Oct. 8, 2026

(54) METHOD FOR UTILIZING TRIGGER DEVICE WITHOUT DISPLAY SCREENS TO SEARCH FOR TARGET BLUETOOTH DEVICE, AND RELATED BLUETOOTH SEARCH DEVICE

(71) Applicant: Realtek Semiconductor Corp., Hsinchu (TW)

(72) Inventors: Chia Chun HUNG, Hsinchu (TW); Hou-Tse HUNG, Hsinchu (TW); Chien Yuan CHEN, Hsinchu (TW)

(73) Assignee: Realtek Semiconductor Corp., Hsinchu (TW)

(21) Appl. No.: 19/678,476

(22) Filed: May 15, 2026

(30) Foreign Application Priority Data
Sep. 25, 2025 (TW) 114137109

(51) Int. Cl. H04W 64/00; H04W 12/0431; H04W 76/10

(52) U.S. Cl. CPC H04W 64/00; H04W 12/0431; H04W 76/10

(57) ABSTRACT

A method for utilizing a trigger device without display screens to search a target Bluetooth device is disclosed including: providing a Bluetooth peripheral device, wherein a pairing key corresponding to the target Bluetooth device is stored in the Bluetooth peripheral device; providing a trigger device without any display screen; establishing a wireless signal connection between the trigger device and the Bluetooth peripheral device; receiving a search instruction issued by a user through the trigger device; utilizing the trigger device to transmit a search request to the Bluetooth peripheral device through the wireless signal connection; and utilizing the Bluetooth peripheral device to search for the position of the target Bluetooth device according to the search request.

### CROSS-REFERENCE TO RELATED APPLICATIONS

This application claims the benefit of priority to Patent Application No. 114137109, filed in Taiwan on Sep. 25, 2025; the entirety of which is incorporated herein by reference for all purposes.

### BACKGROUND

The disclosure generally relates to Bluetooth communication technology and, more particularly, to a method for searching for a position of a target Bluetooth device by utilizing a trigger device without any display screen, and a related Bluetooth search device.

With the development of Bluetooth communication technology, Bluetooth communication protocols have become important standards for interconnecting many electronic devices. Users can connect two devices supporting Bluetooth communication protocols to perform various data or command transmissions.

Existing Bluetooth communication protocols allow users to use a target Bluetooth device with a display screen (such as a mobile phone, tablet, laptop, etc.) to locate a Bluetooth peripheral device that has established a Bluetooth connection with the target Bluetooth device but does not have a display screen (such as Bluetooth earphones, Bluetooth speakers, etc.), in order to help the user find the position of the Bluetooth peripheral device. For example, the target Bluetooth device can use the display screen to visually present the distance or direction of the Bluetooth peripheral device, so that the user can find the Bluetooth peripheral device based on the content on the display screen. Therefore, when a user has a target Bluetooth device with a display screen but has forgotten or lost the position of the Bluetooth peripheral device, the user can use the target Bluetooth device with the display screen to search for the position of the Bluetooth peripheral device.

Conversely, when the user only has a Bluetooth peripheral device without any display screen and has forgotten or cannot find the position of the target Bluetooth device, the user can use the Bluetooth peripheral device to request the target Bluetooth device to emit sound or light via the Bluetooth connection. In this way, the user can find the position of the target Bluetooth device based on the sound or light emitted by the target Bluetooth device.

However, if the target Bluetooth device cannot emit sound or light (for example, does not have the capability to emit sound or light, or the relevant components fail), or the sound or light emitted by the target Bluetooth device cannot be perceived by the user (for example, the sound or light is blocked by objects, or is difficult to identify due to various environmental factors), or the Bluetooth peripheral device is not currently connected to the target Bluetooth device via Bluetooth, then the user cannot use the Bluetooth peripheral device to reversely find the position of the target Bluetooth device. It is clear that traditional Bluetooth device searching mechanisms have many application limitations and are difficult to help users quickly find the position of the target Bluetooth device.

### SUMMARY

An example embodiment of a method for searching for a position of a target Bluetooth device, comprising: providing a Bluetooth peripheral device, wherein a pairing key corresponding to the target Bluetooth device is stored in the Bluetooth peripheral device; providing a trigger device, wherein the trigger device does not have any display screen; establishing a wireless signal connection between the trigger device and the Bluetooth peripheral device; receiving a search instruction issued by a user through the trigger device; utilizing the trigger device to transmit a search request via the wireless signal connection to the Bluetooth peripheral device; and utilizing the Bluetooth peripheral device to search for the position of the target Bluetooth device according to the search request.

An example embodiment of a Bluetooth search device utilized for searching for a target Bluetooth device is disclosed, comprising: a Bluetooth peripheral device, comprising: a first storage circuit arranged to operably store a pairing key corresponding to the target Bluetooth device; a first communication circuit arranged to operably perform Bluetooth communication with the target Bluetooth device; a first control circuit coupled with the first storage circuit and the first communication circuit; and a trigger device, comprising: a second communication circuit arranged to operably perform wireless communication with the first communication circuit; an initiating circuit arranged to operably receive a search instruction issued by a user; an indication message generating device; and a second control circuit coupled with the second communication circuit, the initiating circuit, and the indication message generating device, and arranged to operably control the second communication circuit to establish a wireless signal connection with the first communication circuit, and to operably control the second communication circuit to transmit a search request to the Bluetooth peripheral device via the wireless signal connection when the initiating circuit receives the search instruction; wherein the trigger device does not have any display screen; wherein the first control circuit is arranged to operably control the first communication circuit to search for the position of the target Bluetooth device when the first communication circuit receives the search request.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a Bluetooth communication system according to one embodiment of the present disclosure.

FIG. 2 shows a simplified functional block diagram of the Bluetooth search device of FIG. 1 according to one embodiment of the present disclosure.

FIGS. 3 to 4 collectively show simplified flowchart of a method for searching for the position of a target Bluetooth device according to one embodiment of the present disclosure.

FIGS. 5 to 9 show simplified schematic diagrams of application scenarios of the Bluetooth communication system according to different embodiments of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

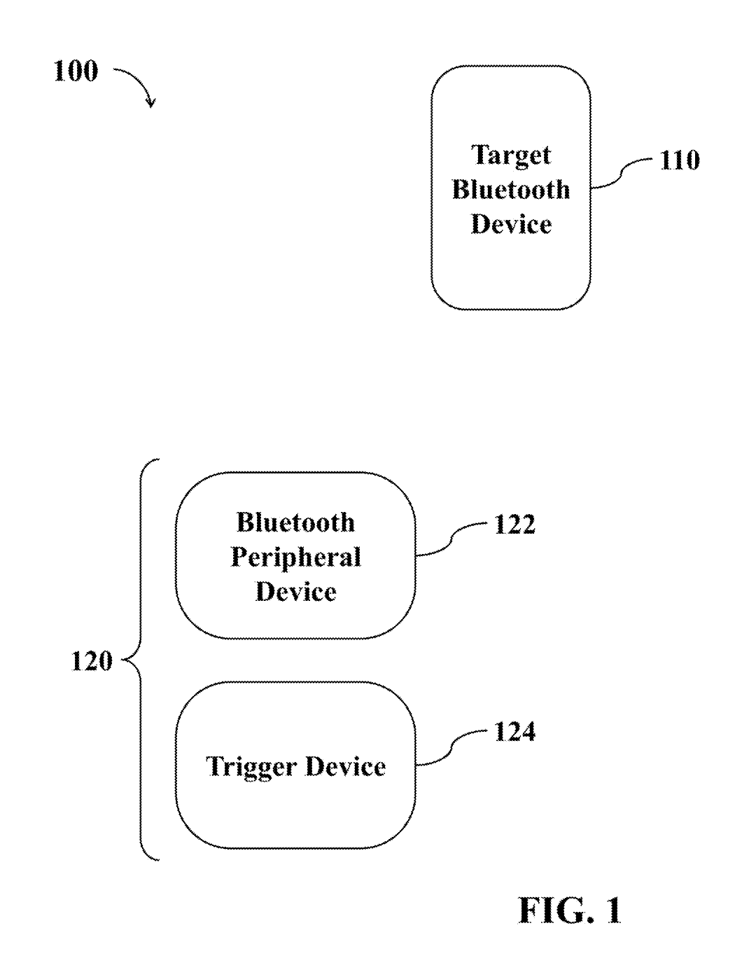

FIG. 1 is a simplified functional block diagram of a Bluetooth communication system 100 according to one embodiment of the present disclosure. The Bluetooth communication system 100 comprises a target Bluetooth device 110, and a Bluetooth search device 120 that can be used to search for the position of the target Bluetooth device 110. As shown in FIG. 1, the Bluetooth search device 120 comprises a Bluetooth peripheral device 122 and a trigger device 124.

Various suitable wireless communication protocols developed by standards setting organizations (SSOs) or proprietary wireless communication protocols defined by individual manufacturers can be used to establish a wireless signal connection between the Bluetooth peripheral device 122 and the trigger device 124. For example, the Bluetooth peripheral device 122 and the trigger device 124 can adopt various Bluetooth communication protocols, near-field communication (NFC) protocols, IEEE 802.11 series communication protocols, or 2.4G/5G proprietary wireless communication protocols to establish the wireless signal connection between each other. Therefore, in some embodiments, the Bluetooth peripheral device 122 may store cypher keys required for conducting wireless transmission with the trigger device 124. Similarly, the trigger device 124 may store cypher keys required for conducting wireless transmission with the Bluetooth peripheral device 122.

In general operation, a user can carry out a Bluetooth pairing process between the target Bluetooth device 110 and the Bluetooth peripheral device 122 of the Bluetooth search device 120 to perform various Bluetooth data transfer operations. In this situation, the target Bluetooth device 110 may negotiate parameters for generating respective cypher keys with the Bluetooth peripheral device 122 and perform various selected or predetermined key algorithms to generate and store pairing keys required for subsequent Bluetooth data transmission with the Bluetooth peripheral device 122. Likewise, the Bluetooth peripheral device 122 may perform various selected or predetermined key algorithms to generate and store the pairing key required for subsequent data transmission with the target Bluetooth device 110.

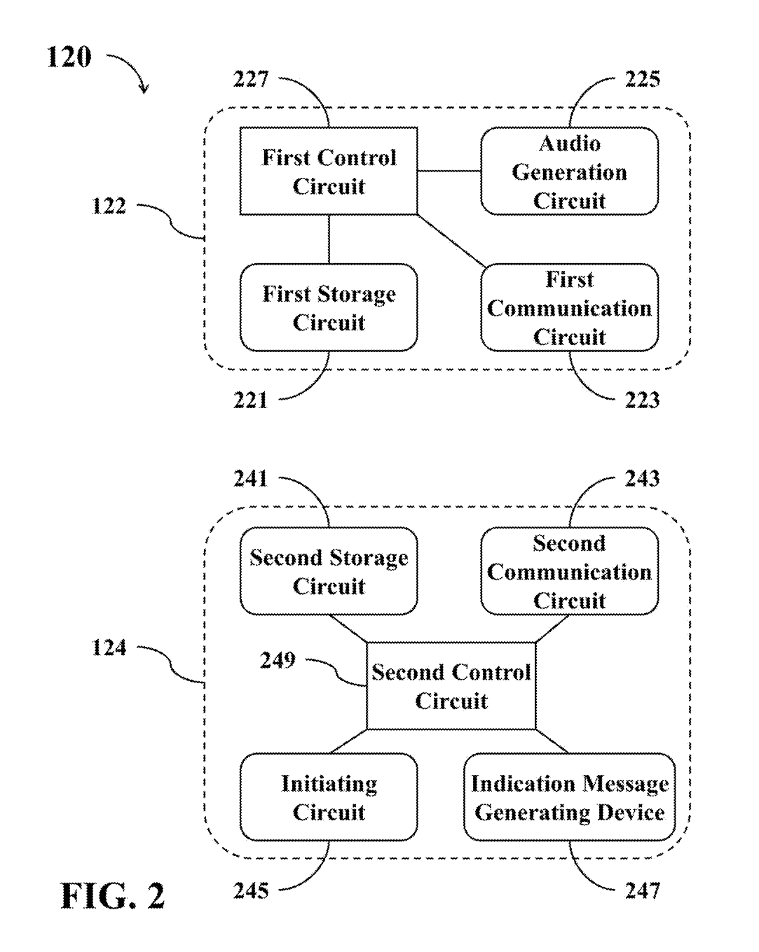

In the embodiment of FIG. 2, the Bluetooth peripheral device 122 comprises a first storage circuit 221, a first communication circuit 223, an audio generation circuit 225, and a first control circuit 227. The trigger device 124 comprises a second storage circuit 241, a second communication circuit 243, an initiating circuit 245, an indication message generating device 247, and a second control circuit 249.

In the Bluetooth peripheral device 122, the first storage circuit 221 is arranged to operably store the pairing key needed for subsequent Bluetooth data transmission with the target Bluetooth device 110. If necessary, the first storage circuit 221 can also store cypher keys needed for wireless communication with the trigger device 124. The first communication circuit 223 is arranged to operably perform Bluetooth communication with the target Bluetooth device 110 and to operably perform wireless communication with the trigger device 124. The audio generation circuit 225 is arranged to operably generate or play audio data under the control of the first control circuit 227. The first control circuit 227 is coupled with the first storage circuit 221, the first communication circuit 223, and the audio generation circuit 225, and arranged to operably control operations of the first storage circuit 221, the first communication circuit 223, and the audio generation circuit 225.

In the trigger device 124, the second storage circuit 241 is arranged to operably store the cypher keys required for wireless communication with the Bluetooth peripheral device 122. The second communication circuit 243 is arranged to operably perform wireless communication with the Bluetooth peripheral device 122. The initiating circuit 245 is arranged to operably receive a search instruction issued by a user. The indication message generating device 247 is arranged to operably generate a distance indication message and/or a direction indication message. The second control circuit 249 is coupled with the second storage circuit 241, the second communication circuit 243, the initiating circuit 245, and the indication message generating device 247, and arranged to operably control operations of the second storage circuit 241, the second communication circuit 243, the initiating circuit 245, and the indication message generating device 247.

In practice, both the first storage circuit 221 and the second storage circuit 241 may be implemented using various types of volatile memory or non-volatile memory. The first communication circuit 223 may be implemented using various suitable circuits capable of conducting Bluetooth communication with the target Bluetooth device 110 and capable of conducting wireless communication with the trigger device 124. The second communication circuit 243 may be implemented using various suitable circuits capable of conducting wireless communication with the Bluetooth peripheral device 122. The audio generation circuit 225 may be implemented using various suitable circuits capable of generating or playing audio data, such as speakers or earphones of various types. Both the first control circuit 227 and the second control circuit 249 may be implemented using packet processing circuits, digital processing circuits, microprocessors, or application specific integrated circuits (ASICs) with appropriate processing capability and capable of parsing and generating wireless packets. The initiating circuit 245 may be realized with various switches, buttons, control knobs, resistive touch circuits, capacitive touch circuits, gyroscopes, voice input devices, gesture sensing devices, circuits employing other command generation techniques, or combinations of the foregoing. The indication message generating device 247 may be realized with various circuits capable of generating sound, voice or vibration operations, such as speakers, earphones, buzzers, vibrators, vibration motors, or combinations thereof.

The different functional blocks in the above-mentioned Bluetooth peripheral device 122 may be implemented with separate circuits, or may be integrated into a single circuit chip. Similarly, the different functional blocks in the trigger device 124 may be implemented with separate circuits, or may be integrated into a single circuit chip.

Please note that in the above-mentioned Bluetooth search device 120, the trigger device 124 does not have any display screen. Therefore, the trigger device 124 is unable to present any images, pictures, or text information to the user.

In common applications, the target Bluetooth device 110 is mostly a device with a display screen (such as a mobile phone, tablet, laptop, etc.). Therefore, when the user has a target Bluetooth device 110 with a display screen but has forgotten or cannot find the position of the Bluetooth peripheral device 122, the user can use the target Bluetooth device 110 with a display screen to locate the position of the Bluetooth peripheral device 122.

On the other hand, when the user has only the Bluetooth search device 120 and has forgotten or cannot find the position of the target Bluetooth device 110, if the target Bluetooth device 110 is capable of emitting sound or light, the user can use the Bluetooth peripheral device 122 to request the target Bluetooth device 110 to emit sound or light via Bluetooth connection. If everything goes smoothly, the user can find the position of the target Bluetooth device 110 by the sound or light emitted from the target Bluetooth device 110.

However, as previously mentioned, if the target Bluetooth device 110 cannot emit sound or light (for example, the target Bluetooth device 110 does not have the capability to emit sound or light, or related components have failed), or the user cannot perceive the sound or light emitted by the target Bluetooth device 110 (e.g., sound or light emitted by the target Bluetooth device 110 is shielded by objects or subject to interference from various environmental factors, such that it is difficult to identify), or the Bluetooth peripheral device 122 is not currently connected to the target Bluetooth device 110, the user is unable to find the position of the target Bluetooth device 110 through the aforementioned conventional methods.

To overcome the application limitations of the conventional approach mentioned above, the Bluetooth communication system 100 of the present disclosure adopts a method significantly different from the conventional approach to help users promptly locate the target Bluetooth device 110.

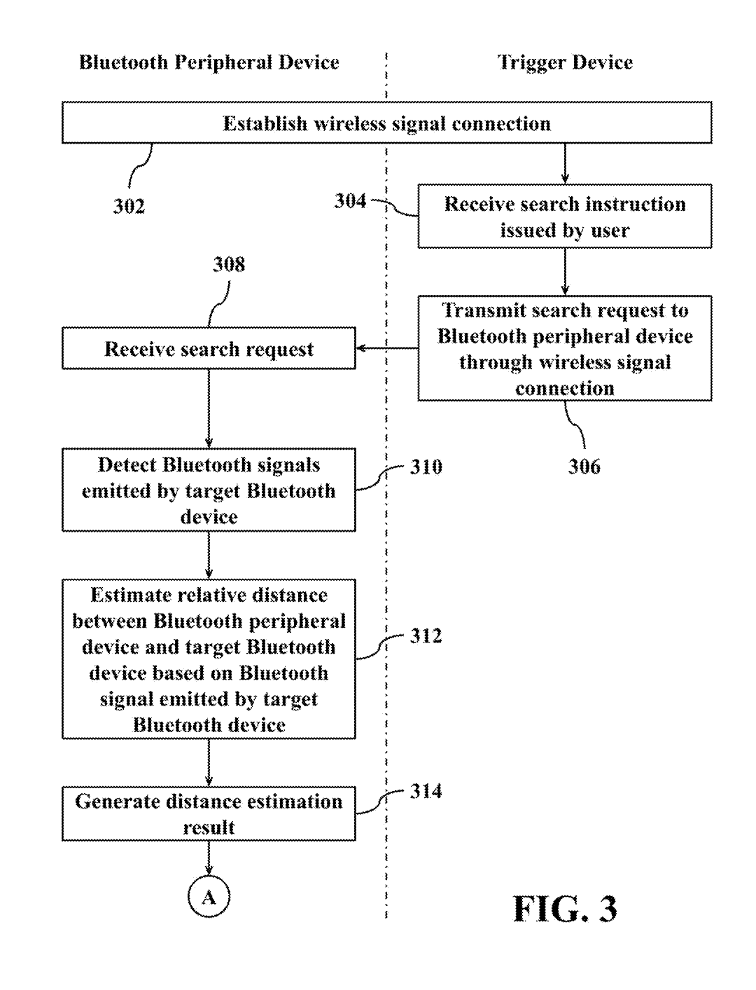

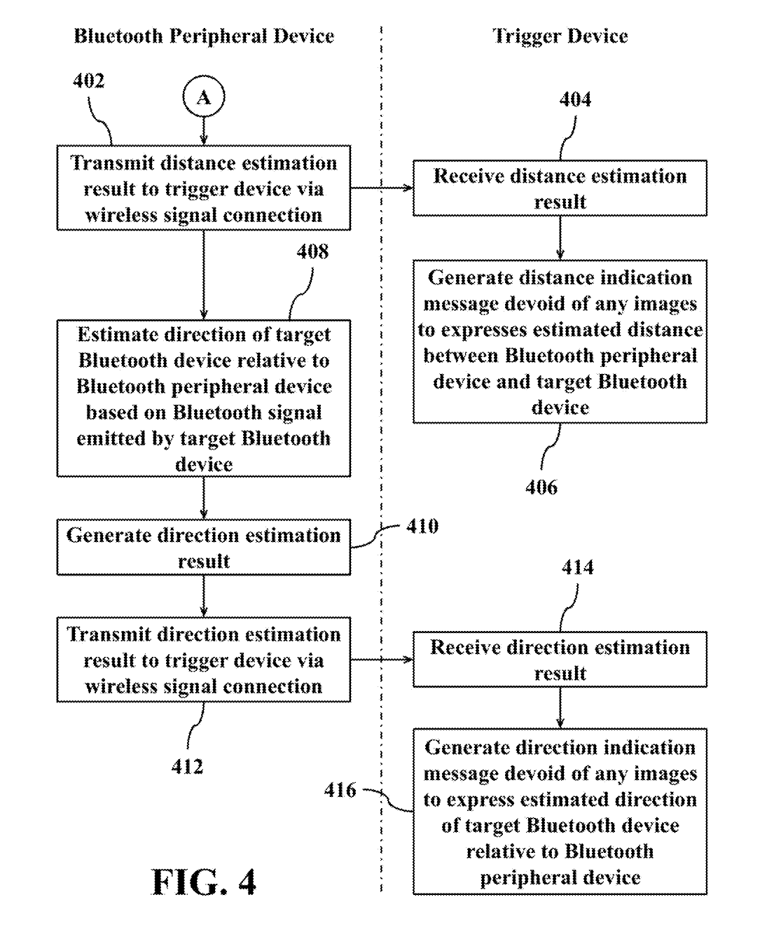

Hereafter, FIGS. 3 and 4 will be used to further explain the operation of using the aforementioned Bluetooth search device 120 to search for the position of the target Bluetooth device 110. FIGS. 3 and 4 collectively show simplified flowchart of a method for searching for the position of a target Bluetooth device according to one embodiment of the present disclosure.

In the flowcharts of FIGS. 3 through 4, operations within a column under the name of a specific device are operations to be performed by the specific device. For example, operations within a column under the label “Bluetooth peripheral device” are operations to be performed by the Bluetooth peripheral device 122; operations within a column under the label “trigger device” are operations to be performed by the trigger device 124.

The Bluetooth search device 120 may perform operation 302 of FIG. 3 at an appropriate time. In practice, the Bluetooth search device 120 may automatically perform operation 302 after power-on. For another example, the Bluetooth search device 120 may perform operation 302 when the user performs a specific operation on the Bluetooth search device 120 (for example, pressing a specific button, bringing the Bluetooth peripheral device 122 and the trigger device 124 close to each other, making the Bluetooth peripheral device 122 and the trigger device 124 contact each other, or separating the Bluetooth peripheral device 122 and the trigger device 124, etc.).

In operation 302, the Bluetooth peripheral device 122 and the trigger device 124 may adopt various suitable wireless communication protocols specified by standards-setting organizations, or proprietary wireless communication protocols defined by manufacturers, to establish and maintain a wireless signal connection. In practice, Bluetooth peripheral device 122 and trigger device 124 may use various Bluetooth communication protocols, near-field communication (NFC) protocols, IEEE 802.11 series communication protocols, or 2.4G/5G proprietary wireless communication protocols to establish and maintain the wireless signal connection between them.

In a scenario where only the Bluetooth search device 120 is accessible and the user has forgotten or is unable to find the position of the target Bluetooth device 110, the user may perform a predetermined operation on the initiating circuit 245 of the trigger device 124 to issue a search instruction to the trigger device 124. In this case, the initiating circuit 245 will perform operation 304 of FIG. 3 to receive the search instruction issued by the user.

For example, if the initiating circuit 245 is implemented with a switch, the user may turn on the initiating circuit 245 to issue a search instruction to the trigger device 124.

For another example, if the initiating circuit 245 is implemented using a button or a touch circuit, the user may press the initiating circuit 245 to issue a search instruction to the trigger device 124.

For yet another example, if the initiating circuit 245 is implemented using a control knob, the user can rotate the initiating circuit 245 to issue a search instruction to the trigger device 124.

For yet another example, if the initiating circuit 245 is implemented using a gyroscope, the user can shake, rotate, or flip the trigger device 124 or the initiating circuit 245 to issue a search instruction to the trigger device 124.

For yet another example, if the initiating circuit 245 is implemented using a gesture sensing device, the user can make a predetermined gesture to the initiating circuit 245 to issue a search instruction to the trigger device 124.

For yet another example, if the initiating circuit 245 is implemented using a voice input device, the user can issue a specific voice command to the initiating circuit 245 to issue a search instruction to the trigger device 124.

When the initiating circuit 245 receives the search instruction issued by the user, the second control circuit 249 may perform operation 306 to generate a search request, and control the second communication circuit 243 to transmit a search request to the Bluetooth peripheral device 122 through the wireless signal connection between the Bluetooth peripheral device 122 and the trigger device 124.

In this situation, the first communication circuit 223 of the Bluetooth peripheral device 122 will perform operation 308 to receive the search request transmitted from the trigger device 124.

When the first communication circuit 223 of the Bluetooth peripheral device 122 receives the search request from the trigger device 124, the first control circuit 227 may perform operation 310 to control the first communication circuit 223 to search for the position of the target Bluetooth device 110. In practice, during operation 310, the first control circuit 227 may control the first communication circuit 223 to detect Bluetooth signals emitted by the target Bluetooth device 110. The aforementioned Bluetooth signals may refer to various Bluetooth advertising packets issued by the target Bluetooth device 110.

In operation 312, the first control circuit 227 may estimate a relative distance between the Bluetooth peripheral device 122 and the target Bluetooth device 110 based on the Bluetooth signal emitted by the target Bluetooth device 110.

For example, in one embodiment, regardless of whether Bluetooth peripheral device 122 and target Bluetooth device 110 are currently in a Bluetooth connection state, the first control circuit 227 can use the first communication circuit 223 to measure the strength of the Bluetooth signal emitted by the target Bluetooth device 110 to estimate the relative distance between the Bluetooth peripheral device 122 and the target Bluetooth device 110. The stronger the strength of the Bluetooth signal emitted by the target Bluetooth device 110, the closer the distance between the Bluetooth peripheral device 122 and the target Bluetooth device 110; conversely, the weaker the strength of the Bluetooth signal emitted by the target Bluetooth device 110, the farther the distance between the Bluetooth peripheral device 122 and the target Bluetooth device 110.

In another embodiment, in operation 312, the first control circuit 227 may control the first communication circuit 223 to use the pairing key stored in the first storage circuit 221 and adopt a Channel Sounding mechanism as defined in the Bluetooth communication protocol to estimate the relative distance between Bluetooth peripheral device 122 and target Bluetooth device 110.

After the first control circuit 227 completes the distance estimation between the Bluetooth peripheral device 122 and the target Bluetooth device 110, it may perform operation 314 to produce a corresponding distance estimation result.

Then, the first control circuit 227 may perform operation 402 of FIG. 4 to control the first communication circuit 223 to transmit the aforementioned distance estimation result to the trigger device 124 via the wireless signal connection between the Bluetooth peripheral device 122 and the trigger device 124.

In this situation, the second communication circuit 243 of the trigger device 124 will perform operation 404 to receive the distance estimation result transmitted from the Bluetooth peripheral device 122.

In operation 406, the second control circuit 249 may, according to the distance estimation result transmitted from the Bluetooth peripheral device 122, control the indication message generating device 247 to generate a distance indication message devoid of any images (i.e., the distance indication message does not comprise any images) to express an estimated distance between the Bluetooth peripheral device 122 and the target Bluetooth device 110. In practice, the aforementioned distance indication message may be implemented with a first predetermined vibration mode, a first predetermined sound, a first predetermined vocal content, or a combination thereof.

The user can determine the relative distance between the Bluetooth peripheral device 122 and the target Bluetooth device 110 based on the distance indication message generated by the indication message generating device 247. Once the user moves the Bluetooth search device 120 (or the Bluetooth peripheral device 122), the relative distance between Bluetooth peripheral device 122 and target Bluetooth device 110 may change accordingly. When the relative distance between Bluetooth peripheral device 122 and target Bluetooth device 110 changes, the distance indication message generated by the indication message generating device 247 will also change accordingly.

For example, if the indication message generating device 247 is implemented with a vibrator or vibration motor, the indication message generating device 247 may vibrate at a lower frequency when the relative distance between Bluetooth peripheral device 122 and target Bluetooth device 110 is closer, and may vibrate at a higher frequency when the relative distance between the Bluetooth peripheral device 122 and the target Bluetooth device 110 is farther.

For another example, if the indication message generating device 247 is implemented with a speaker, earphones, or a buzzer, the indication message generating device 247 may generate a first predetermined sound at a lower frequency or lower volume when the relative distance between Bluetooth peripheral device 122 and target Bluetooth device 110 is closer, and may generate the first predetermined sound at a higher frequency or higher volume when the relative distance between Bluetooth peripheral device 122 and target Bluetooth device 110 is farther.

For yet another example, if the indication message generating device 247 is implemented with a speaker or earphones, the indication message generating device 247 may directly express the relative distance between the Bluetooth peripheral device 122 and the target Bluetooth device 110 in a voice manner.

Thus, the user may move the Bluetooth search device 120 (or the Bluetooth peripheral device 122) to change the relative distance between the Bluetooth peripheral device 122 and the target Bluetooth device 110, and then observe whether the distance indication message generated by the indication message generating device 247 of the trigger device 124 changes. The user may infer the approximate direction and distance of the target Bluetooth device 110 according to the change in distance indication message generated by the indication message generating device 247, thereby locating the position of the target Bluetooth device 110.

For example, according to the above embodiment of the distance indication message, when the user moves the Bluetooth search device 120 (or Bluetooth peripheral device 122) in a first direction for a certain distance, if the user finds that the volume of the distance indication message generated by the indication message generating device 247 becomes quieter, the sound frequency becomes lower, or the vibration frequency becomes lower, the user may infer that the position of the target Bluetooth device 110 should be in the opposite direction to the first direction. In this situation, the user may move the Bluetooth search device 120 (or Bluetooth peripheral device 122) in another direction, and continue to observe whether the distance indication message generated by the indication message generating device 247 changes so as to again infer the approximate direction and distance to the target Bluetooth device 110.

By using the method described above, the user can gradually approach the position of the target Bluetooth device 110 and successfully find the target Bluetooth device 110.

According to the foregoing description, by employing the aforementioned Bluetooth device searching method proposed by the present disclosure, the user is enabled to utilize the trigger device 124 without any display screen in conjunction with the Bluetooth peripheral device 122 to reversely search for the position of the target Bluetooth device 110.

In another embodiment, after performing operation 402 in FIG. 4, the Bluetooth peripheral device 122 continues to perform operation 408.

In operation 408, the first control circuit 227 of the Bluetooth peripheral device 122 may estimate a direction of the target Bluetooth device 110 relative to the Bluetooth peripheral device 122 based on the Bluetooth signal emitted by the target Bluetooth device 110.

For example, in one embodiment, the first control circuit 227 may employ a calculation method defined in the Bluetooth communication protocol to calculate Angle of Arrival (AoA) information or Angle of Departure (AoD) information corresponding to the target Bluetooth device 110 based on the Bluetooth signal emitted by the target Bluetooth device 110, and may accordingly determine a relative direction of the target Bluetooth device 110 according to either the AoA information or the AoD information (or both).

When the first control circuit 227 completes estimation of the direction of the target Bluetooth device 110 relative to the Bluetooth peripheral device 122, it can carry out operation 410 to generate a corresponding direction estimation result.

Then, the first control circuit 227 may proceed with operation 412 to control the first communication circuit 223 to transmit the aforementioned direction estimation result to the trigger device 124 via the wireless signal connection between the Bluetooth peripheral device 122 and the trigger device 124.

In this situation, the second communication circuit 243 of the trigger device 124 perform operation 414 to receive the direction estimation result transmitted from the Bluetooth peripheral device 122.

In operation 416, the second control circuit 249 may, according to the direction estimation result transmitted from the Bluetooth peripheral device 122, control the indication message generating device 247 to generate a direction indication message devoid of any images (i.e., the direction indication message does not contain any images) to express an estimated direction of the target Bluetooth device 110 relative to the Bluetooth peripheral device 122. In practice, the aforementioned direction indication message may be implemented with a second predetermined vibration mode, a second predetermined sound, a second predetermined vocal content, or a combination thereof.

The user can determine the approximate direction of the target Bluetooth device 110 relative to the Bluetooth peripheral device 122 according to the direction indication message generated by the indication message generating device 247. Once the user moves the Bluetooth search device 120 (or the Bluetooth peripheral device 122), the direction of the target Bluetooth device 110 relative to the Bluetooth peripheral device 122 may change. When the relative direction changes, the direction indication message generated by the indication message generating device 247 will also change accordingly.

For example, if the indication message generating device 247 is implemented with a vibrator or vibration motor, the indication message generating device 247 may vibrate in a specific mode (e.g., intermittent short vibration) when the target Bluetooth device 110 is located on the left side of the Bluetooth peripheral device 122, and the indication message generating device 247 may vibrate in another mode (e.g., intermittent long vibration) when the target Bluetooth device 110 is located on the right side of the Bluetooth peripheral device 122.

For another example, if the indication message generating device 247 is implemented with a speaker, earphones, or buzzer, the indication message generating device 247 may generate a second predetermined sound with a specific frequency or volume when the target Bluetooth device 110 is located on the left side of the Bluetooth peripheral device 122, and the indication message generating device 247 may generate another predetermined sound with a different frequency or volume when the target Bluetooth device 110 is located on the right side of the Bluetooth peripheral device 122.

For yet another example, if the indication message generating device 247 is implemented with a speaker or earphones, the indication message generating device 247 may directly use voice manner to express the approximate orientation of the target Bluetooth device 110 (e.g., the target Bluetooth device 110 is located at left direction, front left, right direction, rear right, rear, front, etc.).

Thus, the user may move the Bluetooth search device 120 (or Bluetooth peripheral device 122) to change the direction of the target Bluetooth device 110 relative to the Bluetooth peripheral device 122, and then observe whether the direction indication message generated by the indication message generating device 247 of the trigger device 124 changes. The user may infer the approximate orientation of the target Bluetooth device 110 according to the change in direction indication message generated by the indication message generating device 247, thereby more quickly locating the position of the target Bluetooth device 110.

For example, according to the previous embodiment of the direction indication message, when the user moves the Bluetooth search device 120 (or Bluetooth peripheral device 122) to the left for a certain distance, if the user finds that the volume, frequency, or vibration frequency of the direction indication message generated by the indication message generating device 247 changes, the user may infer that the direction of the target Bluetooth device 110 relative to the Bluetooth peripheral device 122 has changed. In this situation, the user may move the Bluetooth search device 120 (or Bluetooth peripheral device 122) forward or backward, and continue to observe whether the direction indication message generated by the indication message generating device 247 changes so as to more accurately infer the approximate orientation of the target Bluetooth device 110.

In other words, as long as the user simultaneously considers the changes in both the direction indication message and the distance indication message generated by the trigger device 124, the user is enabled to more rapidly find the position of the target Bluetooth device 110.

By employing the aforementioned Bluetooth device searching method proposed in this disclosure, the user not only can utilize the trigger device 124 without any display screen in conjunction with the Bluetooth peripheral device 122 to search for the position of the target Bluetooth device 110, but also can significantly improve searching efficiency and shorten searching time.

In practice, the individual devices in the Bluetooth communication system 100 may have many different forms of implementation. For example, the target Bluetooth device 110 may be realized with a mobile phone, tablet, notebook computer, smart speaker, or music player. The Bluetooth peripheral device 122 may be realized with Bluetooth earphones, a headset, a wearable device, a smart speaker, a Bluetooth printer, or a Bluetooth weight scale. The trigger device 124 may be realized with Bluetooth earphones, a charging case, a charging dock, a power bank, a Bluetooth speaker, a Bluetooth printer, or a Bluetooth weight scale.

In other words, the application scenarios of the Bluetooth communication system 100 described above may have many variations and are not limited to a single application.

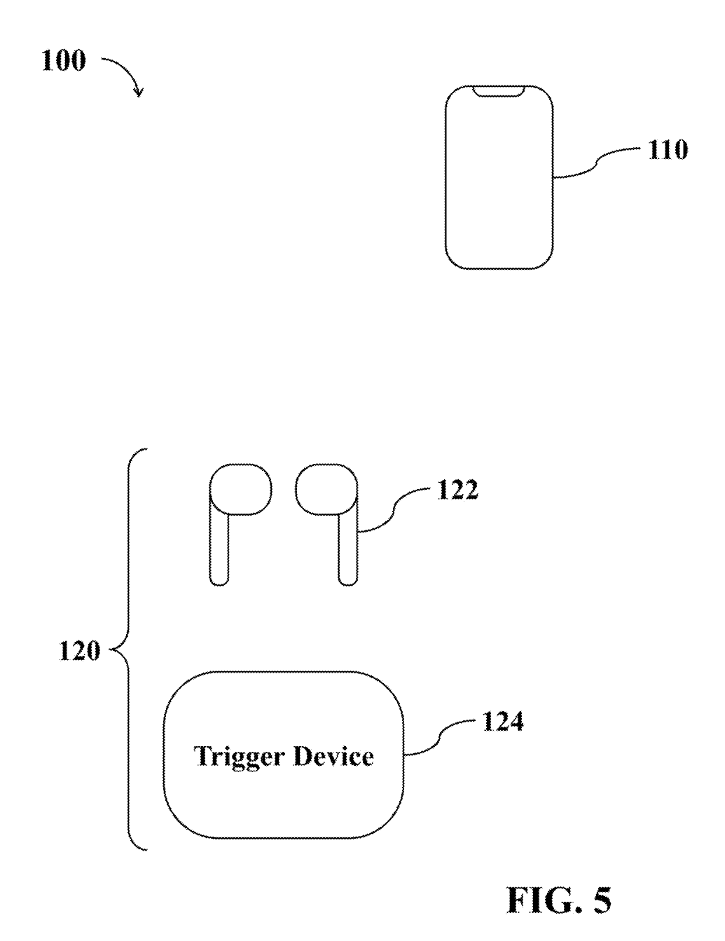

For example, please refer to FIGS. 5 to 9, which show simplified schematic diagrams of application scenarios of the Bluetooth communication system 100 according to different embodiments of the present disclosure.

In the embodiment of FIG. 5, the target Bluetooth device 110 may be implemented in the form of a mobile phone, the Bluetooth peripheral device 122 may be implemented in the form of Bluetooth earphones, and the trigger device 124 may be implemented as a charging case, a charging dock, a power bank, a Bluetooth speaker, and the like.

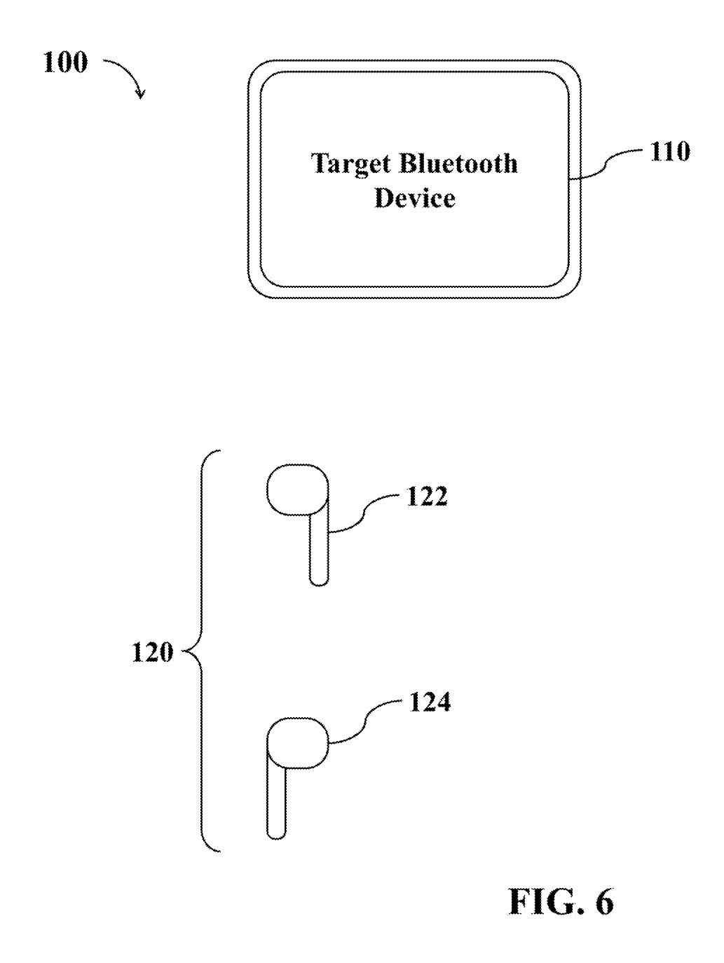

In the embodiment of FIG. 6, the target Bluetooth device 110 may be implemented in the form of a tablet computer, the Bluetooth peripheral device 122 may be implemented in the form of one Bluetooth earphone (e.g., right ear earphone), and the trigger device 124 may be implemented in the form of another Bluetooth earphone (e.g., left ear earphone).

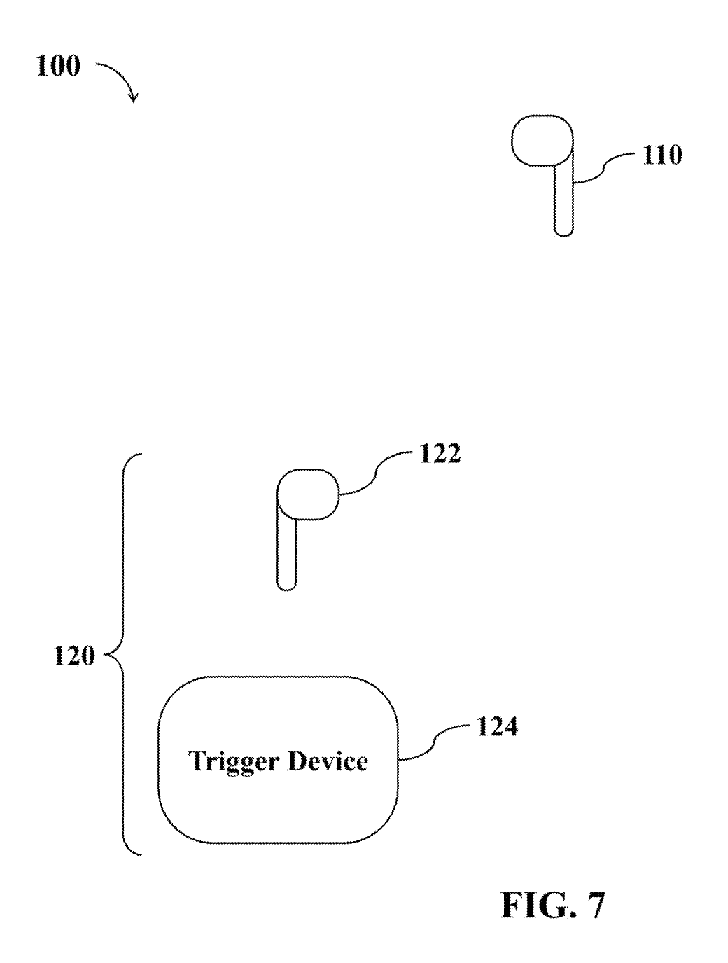

In the embodiment of FIG. 7, the target Bluetooth device 110 may be implemented in the form of one Bluetooth earphone (e.g., right ear earphone), the Bluetooth peripheral device 122 may be implemented in the form of another Bluetooth earphone (e.g., left ear earphone), and the trigger device 124 may be implemented as a charging case, a charging dock, a power bank, a Bluetooth speaker, a Bluetooth printer, a Bluetooth weight scale, and the like.

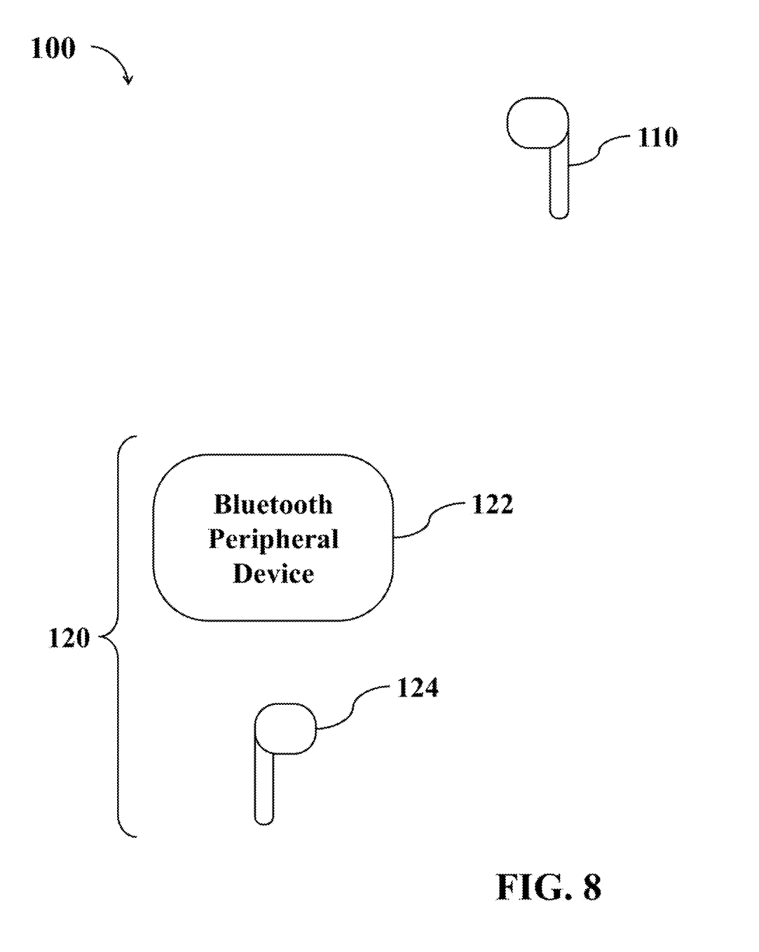

In the embodiment of FIG. 8, the target Bluetooth device 110 may be implemented as one Bluetooth earphone (e.g., right ear earphone), the Bluetooth peripheral device 122 may be as a charging case, a charging dock, a power bank, a Bluetooth speaker, a Bluetooth printer, a Bluetooth weight scale, etc., and the trigger device 124 may be as another Bluetooth earphone (e.g., left ear earphone).

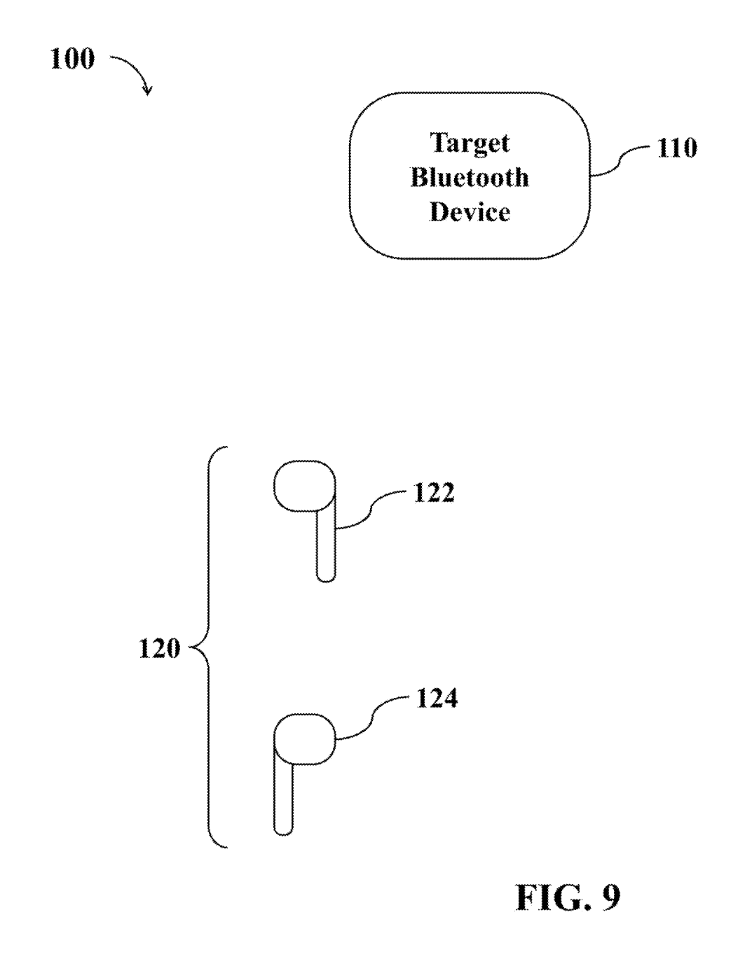

In the embodiment of FIG. 9, the target Bluetooth device 110 may be implemented as a charging case, a charging dock, a power bank, a Bluetooth speaker, a Bluetooth printer, a Bluetooth weight scale, etc., the Bluetooth peripheral device 122 may be implemented as one Bluetooth earphone (e.g., left ear earphone), and the trigger device 124 may be implemented as another Bluetooth earphone (e.g., right ear earphone).

Please note that the application scenarios of Bluetooth communication system 100 shown in FIGS. 5 to 9 are only several exemplary embodiments and are not meant to limit the actual applications of the present invention.

Certain terms are used throughout the description and the claims to refer to particular components. One skilled in the art appreciates that a component may be referred to by different names. This disclosure does not intend to distinguish between components that differ in name but not in function. In the description and in the claims, the term “comprise” is used in an open-ended fashion, and thus should be interpreted to mean “include, but not limited to.” The term “couple” is intended to encompass any indirect or direct connection. For example, if this disclosure mentioned that a first circuit is coupled with a second circuit, it means that the first circuit may be directly or indirectly connected to the second circuit through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A method for searching for a position of a target Bluetooth device (110), comprising:
providing a Bluetooth peripheral device (122), wherein a pairing key corresponding to the target Bluetooth device (110) is stored in the Bluetooth peripheral device (122);
providing a trigger device (124), wherein the trigger device (124) does not have any display screen;
establishing a wireless signal connection between the trigger device (124) and the Bluetooth peripheral device (122);
receiving a search instruction issued by a user through the trigger device (124);
utilizing the trigger device (124) to transmit a search request via the wireless signal connection to the Bluetooth peripheral device (122); and
utilizing the Bluetooth peripheral device (122) to search for the position of the target Bluetooth device (110) according to the search request.

2. The method of claim 1, wherein operation of utilizing the Bluetooth peripheral device (122) to search for the position of the target Bluetooth device (110) according to the search request comprises:
utilizing the Bluetooth peripheral device (122) to detect Bluetooth signals emitted by the target Bluetooth device (110);
utilizing the Bluetooth peripheral device (122) to estimate a relative distance between the Bluetooth peripheral device (122) and the target Bluetooth device (110) based on the Bluetooth signals emitted by the target Bluetooth device (110), and to generate a corresponding distance estimation result;
utilizing the Bluetooth peripheral device (122) to transmit the distance estimation result to the trigger device (124) via the wireless signal connection; and
utilizing the trigger device (124) to generate a distance indication message to express an estimated distance between the Bluetooth peripheral device (122) and the target Bluetooth device (110), wherein the distance indication message comprises a first predetermined vibration mode, a first predetermined sound, or a first predetermined vocal content, but does not contain any images.

3. The method of claim 2, wherein operation of utilizing the Bluetooth peripheral device (122) to estimate the relative distance between the Bluetooth peripheral device (122) and the target Bluetooth device (110) based on the Bluetooth signals emitted by the target Bluetooth device (110) comprises:
utilizing the Bluetooth peripheral device (122) to measure a strength of Bluetooth signals emitted by the target Bluetooth device (110) to estimate the relative distance between the Bluetooth peripheral device (122) and the target Bluetooth device (110).

4. The method of claim 2, wherein the operation of utilizing the Bluetooth peripheral device (122) to search for the position of the target Bluetooth device (110) according to the search request further comprises:
utilizing the Bluetooth peripheral device (122) to detect Bluetooth signals emitted by the target Bluetooth device (110);
utilizing the Bluetooth peripheral device (122) to estimate a direction of the target Bluetooth device (110) relative to the Bluetooth peripheral device (122) based on the Bluetooth signals emitted by the target Bluetooth device (110), and to generate a corresponding direction estimation result;
utilizing the Bluetooth peripheral device (122) to transmit the direction estimation result to the trigger device (124) via the wireless signal connection; and
utilizing the trigger device (124) to generate a direction indication message to express an estimated direction of the target Bluetooth device (110) relative to the Bluetooth peripheral device (122), wherein the direction indication message comprises a second predetermined vibration mode, a second predetermined sound, or a second predetermined vocal content, but does not contain any images.

5. The method of claim 4, wherein operation of utilizing the Bluetooth peripheral device (122) to estimate the direction of the target Bluetooth device (110) relative to the Bluetooth peripheral device (122) based on the Bluetooth signals emitted by the target Bluetooth device (110) comprises:
calculating Angle of Arrival (AoA) information or Angle of Departure (AoD) information corresponding to the target Bluetooth device (110) based on the Bluetooth signals emitted by the target Bluetooth device (110); and
determining the relative direction of the target Bluetooth device (110) in accordance with at least one of the AoA information and the AoD information.

6. The method of claim 2, wherein the operation of utilizing the Bluetooth peripheral device (122) to estimate a relative distance between the Bluetooth peripheral device (122) and the target Bluetooth device (110) comprises:
utilizing the Bluetooth peripheral device (122) to use the pairing key to adopt a Channel Sounding mechanism to estimate the relative distance between the Bluetooth peripheral device (122) and the target Bluetooth device (110).

7. A Bluetooth search device (120) utilized for searching for a target Bluetooth device (110), comprising:
a Bluetooth peripheral device (122), comprising:
a first storage circuit (221) arranged to operably store a pairing key corresponding to the target Bluetooth device (110);
a first communication circuit (223) arranged to operably perform Bluetooth communication with the target Bluetooth device (110);
a first control circuit (227) coupled with the first storage circuit (221) and the first communication circuit (223); and
a trigger device (124), comprising:
a second communication circuit (243) arranged to operably perform wireless communication with the first communication circuit (223);
an initiating circuit (245) arranged to operably receive a search instruction issued by a user;
an indication message generating device (247); and
a second control circuit (249) coupled with the second communication circuit (243), the initiating circuit (245), and the indication message generating device (247), and arranged to operably control the second communication circuit (243) to establish a wireless signal connection with the first communication circuit (223), and to operably control the second communication circuit (243) to transmit a search request to the Bluetooth peripheral device (122) via the wireless signal connection when the initiating circuit (245) receives the search instruction;
wherein the trigger device (124) does not have any display screen;
wherein the first control circuit (227) is arranged to operably control the first communication circuit (223) to search for the position of the target Bluetooth device (110) when the first communication circuit (223) receives the search request.

8. The Bluetooth search device (120) of claim 7, wherein the first control circuit (227) is further arranged to operably utilize the Bluetooth peripheral device (122) to detect Bluetooth signals emitted by the target Bluetooth device (110); to operably estimate a relative distance between the Bluetooth peripheral device (122) and the target Bluetooth device (110) based on the Bluetooth signals emitted by the target Bluetooth device (110), and generate a corresponding distance estimation result; and to operably control the first communication circuit (223) to transmit the distance estimation result to the trigger device (124) via the wireless signal connection;
wherein the second control circuit (249) is further arranged to operably, when the second communication circuit (243) receives the distance estimation result, control the indication message generating device (247) to generate a distance indication message expressing an estimated distance between the Bluetooth peripheral device (122) and the target Bluetooth device (110);
wherein the distance indication message comprises a first predetermined vibration mode, a first predetermined sound, or a first predetermined vocal content, but does not comprise any images.

9. The Bluetooth search device (120) of claim 8, wherein the first control circuit (227) is further arranged to operably utilize the first communication circuit (223) to measure a strength of the Bluetooth signals emitted by the target Bluetooth device (110) to estimate the relative distance between the Bluetooth peripheral device (122) and the target Bluetooth device (110).

10. The Bluetooth search device (120) of claim 8, wherein the first control circuit (227) is further arranged to operably utilize the Bluetooth peripheral device (122) to detect Bluetooth signals emitted by the target Bluetooth device (110); to operably estimate a direction of the target Bluetooth device (110) relative to the Bluetooth peripheral device (122) based on the Bluetooth signals emitted by the target Bluetooth device (110), and generate a corresponding direction estimation result; and to operably control the first communication circuit (223) to transmit the direction estimation result to the trigger device (124) via the wireless signal connection;
wherein the second control circuit (249) is further arranged to operably, when the second communication circuit (243) receives the direction estimation result, control the indication message generating device (247) to generate a direction indication message expressing an estimated direction of the target Bluetooth device (110) relative to the Bluetooth peripheral device (122);
wherein the direction indication message comprises a second predetermined vibration pattern, a second predetermined sound, or a second predetermined vocal content, but does not comprise any images.

11. The Bluetooth search device (120) of claim 10, wherein the first control circuit (227) is further arranged to operably calculate Angle of Arrival (AoA) information or Angle of Departure (AoD) information corresponding to the target Bluetooth device (110) based on the Bluetooth signals emitted by the target Bluetooth device (110); and to operably determine a relative direction of the target Bluetooth device (110) according to at least one of the AoA information and AoD information.

12. The Bluetooth search device (120) of claim 9, wherein the first control circuit (227) is further arranged to operably control the first communication circuit (223) to use the pairing key to adopt a Channel Sounding mechanism to estimate the relative distance between the Bluetooth peripheral device (122) and the target Bluetooth device (110).
